(19) United States
(12) Patent Application Publication
(10) Pub. No.: US 2010/0206884 A1
(43) Pub. Date: Aug. 19, 2010

(54) GAS BURNER BOILING POT

(76) Inventor: Todd Bard Tunstall, Madisonville, LA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 12/435,917

(22) Filed: May 5, 2009

Related U.S. Application Data
(60) Provisional application No. 61/050,840, filed on May 6, 2008.

(51) Int. Cl. A47J 27/00; B23P 17/00

(52) U.S. Cl. 220/573.1; 29/592

(57) ABSTRACT

A pot, having a bottom and a continuous sidewall, defining a fluid or substance containing space therein. The pot further includes a plurality of fins extending along the bottom exterior surface of the pot, in various configurations, but preferably in a series of raised, curved arms that radiate out from the center of the pot and terminate at its outer edge, defining a plurality of spaces between each radiating arm. This configuration of raised, radiating arms along the exterior bottom wall of the pot increase the surface area of the bottom of the pot and absorbs the heat from the gas burner into the pot, thereby increasing the heating performance of the liquid or substance being heated therein. There may be further provided small mounds or waves on the interior bottom of the pot for further increasing the surface of the pot interior, which helps channel the heat in a circular motion, and helps induction of heat into the substance. A second embodiment includes a plurality of metal dowel members secured to the bottom of a container to absorb the heat from the gas burner into the pot, thereby increasing the heating performance of the liquid or substance being heated therein.

### CROSS-REFERENCE TO RELATED APPLICATIONS

Priority is claimed to U.S. Provisional Patent Application Ser. No. 61/050,840, filed May 6, 2008, incorporated herein by reference.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to vessels, such as pots, for heating various liquid or slurry substances over gas heat. More particularly, the present invention relates to an improved pot which provides a tuned thermal sink along the bottom portion of the pot to conduct a greater amount of the heat from the gas flame and greatly reduce the heat lost to the atmosphere.

2. General Background of the Invention

It is universal that in the cooking of certain liquid containing food items, that require boiling, the use of a pot to contain the food item is used over an open gas flame. This practice has been conducted for virtually centuries. The shortcomings in this method is that although a pot placed over an open flame receives heat directly to its bottom to heat the contents of the pot, a great amount of heat is lost along the edge of the pot and the heat is dissipated to atmosphere. This is a very inefficient use of natural gas, while at the same time releasing unwanted heat into the atmosphere of the kitchen or wherever the heating is taking place.

Although there have been non stick pots, such as Teflon coated pots, or pots of certain material, the result is still the same. The amount of heat lost during the process is a great loss of much needed energy.

There is therefore a need in the industry to provide a design for a heating container, such as a metal pot, which improves substantially the efficiency of heat conduction from the gas burner into the pot, causing the liquid or substance to rise higher in temperature at a faster pace, thus saving energy.

For purposes of this application, the terms pot, and container shall have the same meaning of a vessel capable of heating liquid or other substances within the vessel, preferably under natural gas, but not necessarily restricted to natural gas as the fuel.

The following U.S. patents are incorporated herein by reference:

TABLE

| Pat. No. | Title | Issued Date |
|---|---|---|
| 33,366 | Sheet Metal Vessel | Oct. 16, 1900 |
| 52,016 | Baking Dish | May 07, 1918 |
| 3,799,048 | Disposable Cooking Utensil with even | Mar. 26, 1974 |
| | Heating | |
| 5,357,850 | Cooking Vessel Having a Base Which is | Oct. 25, 1994 |
| | Non-Deformable Under Action of Heat | |
| 5,564,589 | Pot or Pan | Oct. 15, 1996 |
| D392,840 | Cookware Radially Grooved Exterior | Mar. 31, 1998 |
| | Bottom Surface | |
| 6,244,615 | Individual Snowboard For Each Foot | Jun. 12, 2001 |
| US2008/ | Energy Efficient Cookware | Sep. 18, 2008 |
| 0223359 | | |

### BRIEF SUMMARY OF THE INVENTION

The apparatus of the present invention solves the problems in the art in a simple and straightforward matter. What is provided is a pot, having a bottom and a continuous sidewall, defining a fluid or substance containing space therein. The pot further includes a plurality of fins extending along the bottom exterior surface of the pot, in various configurations, but preferably in a series of raised, curved arms that radiate out from the center of the pot and terminate at its outer edge, defining a plurality of spaces between each radiating arm. This configuration of raised, radiating arms along the exterior bottom wall of the pot increase the surface area of the bottom of the pot and absorbs the heat from the gas burner into the pot, thereby increasing the heating performance of the liquid or substance being heated therein.

There may be further provided small mounds or waves on the interior bottom of the pot for further increasing the surface of the pot interior, which helps channel the heat in a circular motion, and helps induction of heat into the substance.

This configuration is defined as a tuned thermal sink, which is a heat exchange device which converts the energy collected from the hot gases from the burner to the liquid side of the sink (interior of the pot) with very little resistance. The ratio between the surface area on the gas side of the sink is in proportion to the liquid side of the sink making it an efficient movement of energy between the gas side and the liquid side.

Therefore it is a principal object of the present invention to provide a pot, pan or other container which includes fins or arms on the bottom exterior of the pot, and which can be configured in various shapes, but preferably should extend to the outside edge of the bottom of the pot for optimum performance.

It is a further principal object of the present invention to provide a pot, pan or other container having a tuned thermal sink forged into the exterior bottom of the container for increasing the surface area on the bottom of the container in order to absorb more heat into the container and less heat dissipated to atmosphere.

It is a further principal object of the present invention to provide a pot, pan or other container to provide a means on the bottom exterior of the container which is configured to provide greater absorption of heat from a gas burner so that the contents of the container are heated almost 50% faster than conventional containers, and is therefore more energy efficient.

It is a further principal object of the present invention to provide a pot, pan or other container wherein the interior bottom of the container may have small mounds or bumps or waves, also increasing the surface of the interior pot, which assists in channeling the heat in a circular motion, and helps induction of heat into the substance in the container.

It is a further principal object of the present invention to provide a pot, pan or other container having a plurality of spaced apart raised elements extending outward from the outer surface of the bottom of the pot to provide greater absorption of heat from a gas burner so that the contents of the container are heated faster than conventional containers, and is therefore more energy efficient.

The exterior fins or arms, and the spaced apart raised elements, increase the surface area of the bottom of the pot and absorb the heat from the gas burner into the pot, thereby increasing the heating performance of the liquid or substance being heated. This new design also provides that because the exterior fins or raised elements absorb the heat into the pot, there is far less heat escaping from around the sides of the pot at the burner level as happens in conventional pots, thus improving the cooking area (kitchen) as there is far less heat wasting, making the environment cooler in which to work, again saving energy.

This new design also provides that the substance within the pot is brought up to temperature faster than in conventional regular pots, saving energy, time, and money.

Preliminary tests on an aluminum prototype having the new design as discussed above showed a 43% increase in overall performance, indicating that, after research and development, the final product should achieve even greater performance.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is an overall view of the exterior bottom of a container in the preferred embodiment of the apparatus of the present invention illustrating the radiating arms on the bottom of the container;

FIG. 2 is a view of the preferred embodiment of the interior of the apparatus of the present invention illustrating the raised concentric circles on the interior bottom of the pot for facilitating heating the contents of the pot;

FIG. 3 is a view of a second preferred embodiment of the interior of the apparatus of the present invention illustrating the raised mounds on the interior bottom of the pot for facilitating heating the contents of the pot;

FIG. 4 illustrates an underside view of an additional embodiment of the heat sink feature on the bottom of the containing having a plurality of spaced apart metal dowels secured to the bottom of the container;

FIG. 5 illustrates an isolated view of the embodiment illustrated in FIG. 4;

FIG. 6 illustrates a side view of the embodiment illustrated in FIG. 4;

FIG. 7 illustrates the interior of the pot incorporating the embodiment of the heat sink as illustrated in FIG. 4; and

FIG. 8 illustrates a third embodiment of the heat sink feature on the bottom of the pot.

Exhibit 1 is a Green Pot Graph which provides a comparison of a pot used in the preferred embodiment of the present invention with a conventional pot during the heating process.

Exhibit 2 is a Chart comparing of the results shown in Exhibit 1 in a column format.

### DETAILED DESCRIPTION OF THE INVENTION

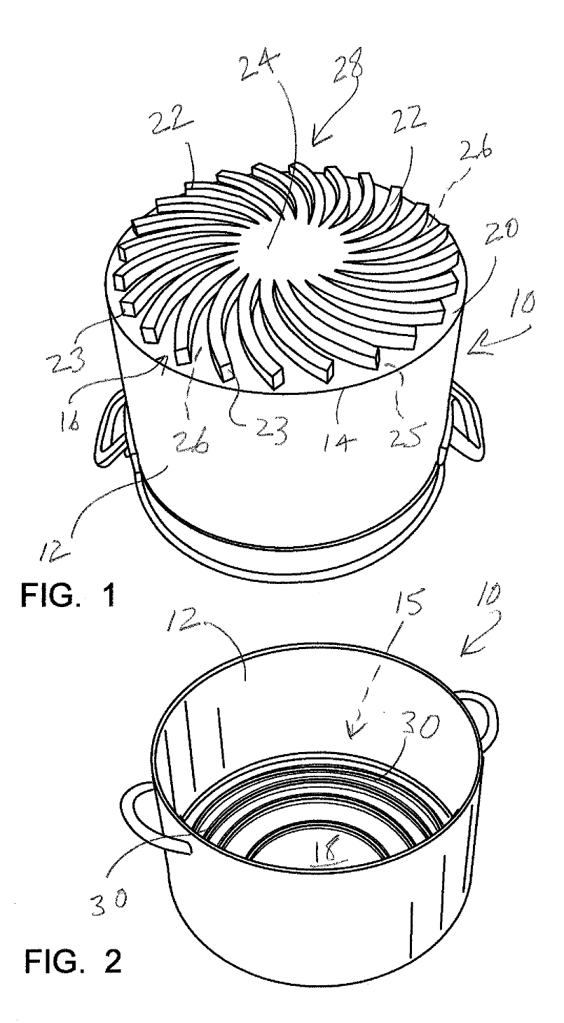

FIGS. 1 through 8 illustrate the preferred embodiments of the container of the present invention by the numeral 10. Although there are several principal embodiments it should be made clear that all embodiments relate to a tuned thermal sink forged into the exterior bottom of the container for increasing the surface area on the bottom of the container in order to absorb more heat into the container and less heat dissipated to atmosphere.

In the figures there is provided the container 10, which is shown as a large pot used primarily for heating liquids. As seen container 10 provides a continuous circular sidewall 12, terminating at its bottom edge 14 into a circular bottom 16. In such a pot 10, the top is open, thus defining a space therein for heating the fluid or other substance therein.

In the preferred embodiment bottom 16 provides a thickened exterior floor 20, preferably of an aluminum or other heat conducting substance fused through conventional process to the bottom 16 of the pot 10, and being of a equal diameter of pot 10. In the embodiment illustrated the exterior floor 20 would provide a plurality of raised arms 22 radiating out from a center point 24 and each arm 22 terminating at end 23 near the far edge 14 of pot 10, but allowing about a ½″ space 25 between the edge 14 and end 23 of each arm 22 to facilitate better heating. There is further defined a plurality of spaces 26 between each of the radiating arms 22. In the preferred embodiment the arms would be 2.54 cms in height and 1.25 cms in thickness. This configuration of arms 22 as illustrated would be defined in the art as a tuned thermal sink 28 formed on the bottom of the pot.

It should be noted that although the pot 10 is an aluminum pot, the invention is not so limited, but would be applicable to any substance of which a pot or container could be constructed, which would be used for heating a substance therein. Furthermore, although the configuration as illustrated is radiating arms 22, the present invention would also apply to any configuration along the bottom of a pot which would provide the same or similar results in heat transfer as preferred embodiment.

In FIG. 2 there is illustrated pot 10 in its interior configuration. Reference is made to the interior 15 of pot 10 where there is provided plurality of raised concentric circles 30 formed in the interior surface 18 of the pot 10. These plurality of raised circles 30 provide an additional means to capture the heat from the tuned heat sink and transfer it to the liquid substance within the pot 10.

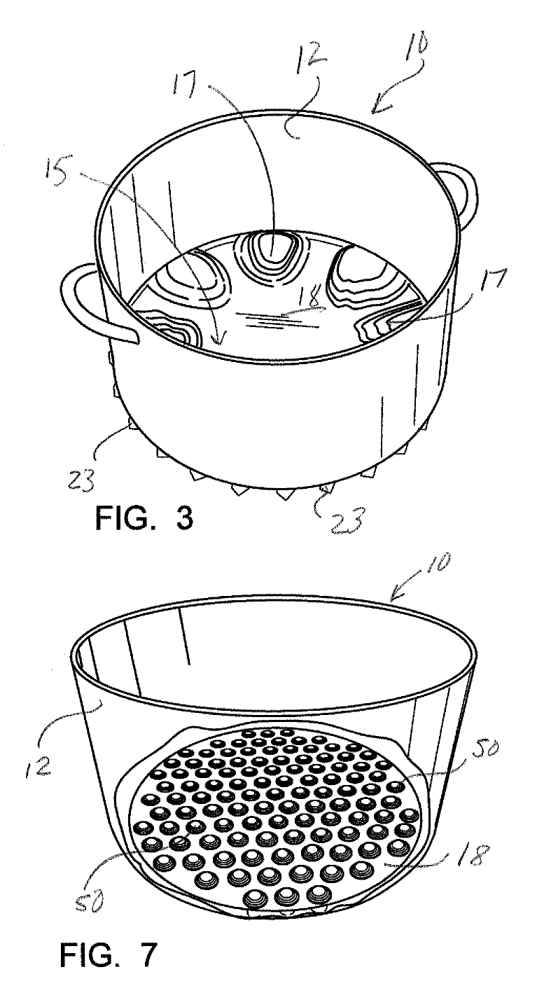

In FIG. 3, there is illustrated in partial view the interior 15 of the pot 10 wherein the pot 10 also contains smaller mounds 17 on the interior bottom of the pot 10. The exterior arms 22 would define a tuned thermal sink and the concentric circles 30 or mounds 17 help channel the heat in a circular motion to heat the contents of the pot 10.

In operation, the fins or arms 22 absorb the heat from a gas burner because the substance inside the pot 10 is much cooler than the temperature of the flame. The heat from the flame is induced into the arms 22, traveling to the interior surface 18 of the bottom 16 of the pot 10, where the substance absorbs the heat. The exterior arms 22 on the bottom 16 of the pot 10 create a larger surface area for the heat to induce itself into the bottom interior of the pot 10.

As expressed earlier, the pot 10 can be made of stainless steel with copper fins. A pot 10 can be made of aluminum with aluminum fins, or constructed from cast iron with cast iron fins, although this would not be as efficient as copper or aluminum. A pot 10 can be made of stainless steel with stainless steel fins, again, or any other heat conducting substance of which pots can be made now or in the future.

The ratios between the arms 22 on the bottom exterior and the mounds on the bottom interior are calculated to provide maximum movement of heat from the flame through the bottom into the substance in the pot 10. The arms 22 need to be a part of the pot 10 (a solid structure) to maximize the greatest transfer of energy.

The aluminum prototype of the pot 10 includes a total of 24 radiating arms 22, approximately ½ inch (2.25 cm) thick. The number and thickness of the arms 22 determine the overall absorption rate of heat that the bottom 16 of pot 10 can pick up. If the arms 22 were thinner and more of them, the performance should be even greater.

Additionally, the cooking or boiling pot 10 designed with elevated arms 22 on the exterior bottom 16 are configured like waves of a hurricane. The purpose of the elevated “waves” or arms 22 is to dramatically increase the surface area of the bottom of the pot 10. The pot also contains smaller waves on the interior bottom of the pot 10. The exterior “waves” or arms 22 would define a tuned thermal sink and the interior “waves” help channel the heat in a circular motion. The hurricane shape of the exterior waves allows the pot 10 to sit on the burner evenly. This design improves substantially the efficiency of heat conduction from the gas burner into the pot, thereby reducing the time it takes the liquid to come to a boil as well as the food to come to a second boil after that food is inserted into the boiling liquid over a gas burner. This is a critical aspect when boiling crawfish or shrimp. This will also improve gas cooking in general, whether it is in small home pots or large commercial pots such as in restaurants.

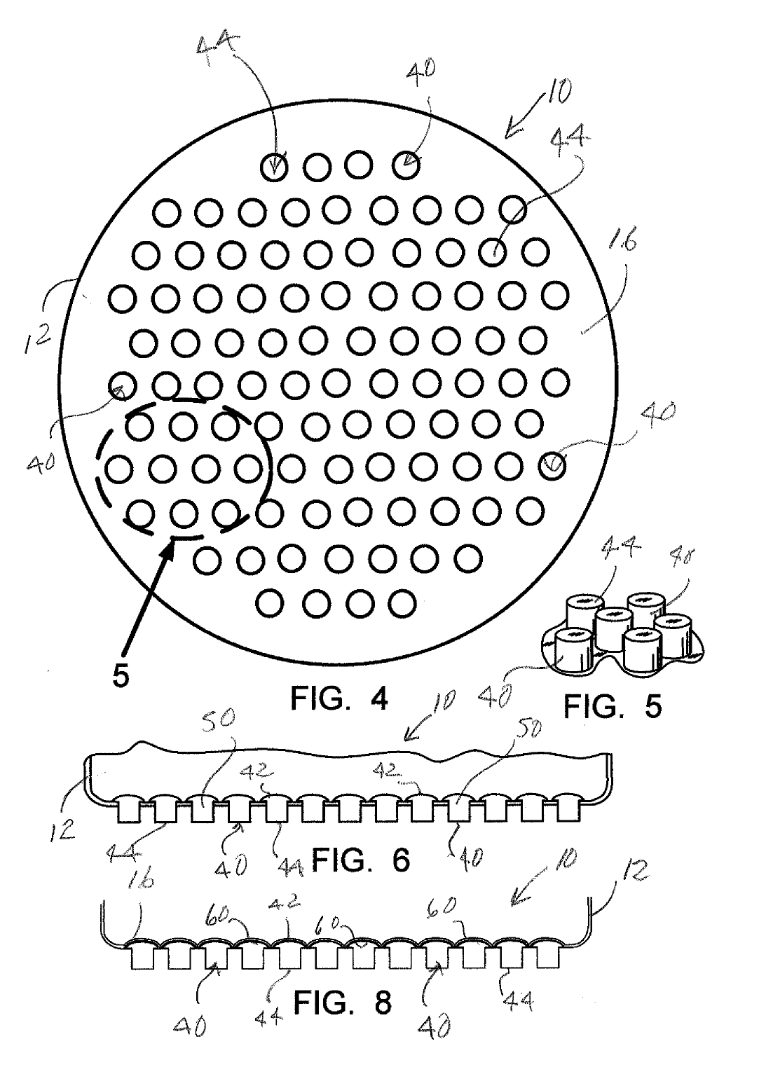

FIGS. 4 through 8 illustrate various views of an additional preferred embodiment of the present invention. As illustrated pot or container 10 includes a flat bottom portion 16 further comprising a plurality of spaced apart dowel members 40, each having a first end 42 which is secured to the bottom 16 of the container 10, through heat treatment or the like. FIG. 6 illustrates a preferred manner to secure the dowels to the pot, as will be discussed further.

In each embodiment the dowels 40 extend outward from the bottom 16, preferably at least 0.50 centimeters up to 3.25 centimeters to a flat distal end 44, so that the distal ends 44 of the dowel members 40 are all extending equidistant from the bottom 16 of the container 10, to collectively provide a flat surface which can be set upon a gas or electric burner. As with the previous embodiment, it is desired that this configuration, in operation, the members 40 absorb the heat from a gas burner because the substance inside the pot 10 is much cooler than the temperature of the flame. The heat from the flame is induced into the members 40, traveling to the interior surface of the bottom 16 of the pot 10, where the substance absorbs the heat. The exterior members 40 on the bottom 16 of the pot 10 create a larger surface area for the heat to induce itself into the bottom interior of the pot 10. It is foreseen that the dowel members 40 would be spaced over the entire bottom 16 of a container 10 to provide a large surface area in which heat would be conducted into the container as efficiently as possible.

In this embodiment, as was stated earlier, the dowels 40 on the exterior bottom 16 of the pot 10 would preferably range from 0.50 centimeters up to 3.25 centimeters (⅛ to ¾ of an inch) in height, depending on the size of the pot. This embodiment would also include mounds 17 on the inside bottom of the pot range from 1.25 cms to 3.25 cms (⅜ to 1 inch) in height, depending on the size of the pot. On extremely large pots, the sizes may even be greater. The purpose of the dowels 40 on the exterior bottom 16 is to increase the surface area; thereby increasing thermal absorption from the hot gases emitted from the burner. Likewise, the interior mounds 17 increase the surface area of the interior surface 18 of the pot 10, allowing the thermal energy to move into the liquid more efficiently. In effect, the improved bottom of the pot, both exterior and interior, creates a tuned thermal sink.

The average distance between the dowels and the edge of the pot is about ½ inch. Again, this distance depends on the size of the pot. The reason for this is so that hot gases from the burner can flow evenly around the curved edge of the pot and up the exterior walls efficiently.

As illustrated in FIGS. 6 and 7, the interior surface 18 of the embodiment of the pot 10 illustrated in FIG. 4 provides a plurality of raised knobs 50, each knob 50 corresponding in location to the first end 42 of each dowel 40 on the underside 20 of the pot 10. As illustrated the knobs 50 are interconnected to each dowel 40, and are heat sealed to the bottom 16 of the pot, either through heat treatment of through other process. The knobs 50, as with the raised mounds 17, serve to distribute heat within the pot more efficiently, adding to the thermal heat sink effect.

An alternate manner of securing the dowels 40 to the bottom 16 of the pot 10 is to provide a plurality of dimples or recesses 60 in the bottom 16 of the pot 10. An end of a dowel 40 would be welded at each recess to define the plurality of dowels configured as seen in FIG. 8. The knobs 60 on the bottom inside the pot 10 can be pressed from the exterior of the bottom of the pot 10; then, the dowels 40 can be resistive welded or friction welded to the bottom 16 of the pot 10. There can be other ways of attaching the dowels 40 to the bottom of the pot 10. The actual dowels 40 are shown as circular, they can also be various shapes, such as square or hex or the like. This manner or attachment would not compromise the integrity of the bottom 16 of the pot 10, as an alternative to securing the dowels 10 through the pot bottom 16 as discussed in FIG. 6.

There are various methods, but preferably two methods, by which this pot can be manufactured. It can be cast as one aluminum vessel, which would be easy to do with smaller pots. On larger pots, the exterior dowels and interior pumps can be resistive welded from the inside of the pot out. The dowels and pumps can be all one piece, similar to a rivet. This pot can be stainless steel, cast iron, aluminum and possibly copper.

### Test Results

Tests were conducting utilizing the preferred embodiment of the pot 10 of the present invention, as illustrated in FIGS. 1 and 2 with a conventional pot. Both pots were of the same volume and both had the same quantity of the same liquid therein. Both pots were subjected to the same amount of heat from the same conventional gas burner, of the same BTU output. The results are set forth in the Green Pot Graph attached as Exhibit 1 and the Chart attached as Exhibit 2.

A comparison of the amount of time the heating took place against the temperature in Fahrenheit achieved, clearly shows the efficiency of the present invention, which when total resulted in a 43% greater heating efficiency than a conventional pot. For example in Exhibit 1, in a 24 quart pot containing 6 quarts of water, after 500 seconds the present invention had achieved a temperature of 210 degrees F. while a conventional pot had achieved that same temperature in 900 seconds. The same type of results is shown when the liquid was heated in a 24 quart pot containing 10 quarts of water, where after 700 seconds, the invention achieved a temperature of 210 degrees F., where that same temperature was not achieved by a conventional 24 quart pot until 1200+ seconds.

From these test results it is clear that the present invention provides a dramatically more efficient container for heating substances over a natural gas burner, which results is less gas usage, more energy efficient cooking, and less heating of the surrounding atmosphere.

The following is a list of parts and materials suitable for use in the present invention:

PARTS LIST

| Parts Number | Description |
|---|---|
| 10 | container or pot |
| 12 | circular sidewall |
| 14 | bottom edge |
| 15 | interior |
| 16 | circular bottom |
| 17 | mounds |
| 18 | interior surface |
| 20 | exterior floor |
| 22 | raised arms |
| 23 | end |
| 24 | center point |
| 26 | spaces |
| 28 | tuned heat sink |
| 30 | concentric circles |
| 40 | dowel members |
| 42 | first end |
| 44 | distal end |
| 50 | knobs |
| 60 | dimples |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. An improved container for heating fluid and like substances, comprising:
a. a closed wall portion;
b. a floor portion;
c. the wall and floor portion defining a space for holding the fluid to be heated;
d. a plurality of raised arms radiating outward from a center of the exterior of the floor portion to define a tuned thermal sink for capturing a greater quantity of heat from the gas burner and directing the heat into the container for heating the substance within the container to the desired temperature in a shorter time than a conventional container.

2. The improved container in claim 1, wherein the container is constructed of aluminum, cast iron, copper, or any other suitable compound capable of heating substances therein.

3. The improved container in claim 1, wherein the container is approximately 43% greater in heating efficiency than in a conventional heating container.

4. The improved container in claim 1, wherein the plurality of raised arms define a greater overall surface area wherein heat is conducted from the burner to the contents within the container.

5. The improved container in claim 1, wherein the raised arms on the underside of the container floor portion may comprise different configurations other than radiating arms, provided that the configuration would provide as good or better heating efficiency as do the radiating arms configuration.

6. An improved pot, to be heated over a natural gas burner, the pot having a sidewall and a floor portion to define a fluid or substance containing space therein; the improvement comprising:
a plurality of raised members secured to the underside of the pot floor portion to define a means for capturing a greater quantity of heat from the gas burner and directing the heat into the container for heating the substance within the container to the desired temperature in a shorter time than a conventional container while reducing the amount of heat lost to the atmosphere.

7. The improved pot in claim 6, wherein the pot may be constructed of aluminum, cast iron, copper, or any other suitable compound capable of heating substances therein.

8. The improved pot in claim 6, wherein the pot is approximately 43% greater in heating efficiency than in a conventional heating container.

9. The improved pot in claim 6, wherein the plurality of raised members define a greater overall surface area wherein heat is conducted from the burner to the contents within the container.

10. The improved pot in claim 6, wherein the raised members on the underside of the container floor portion may comprise a plurality of configurations, provided that the configurations would provide as good or better heating efficiency as do the radiating arms configuration.

11. The improved pot in claim 6, wherein the raised members comprise a plurality of metal dowels each having an end portion terminating on an interior surface of the bottom of the pot, and further defining a knob raised from the interior bottom while the dowel extends from the exterior bottom of the pot.

12. An improved container for heating fluids and the like substances over a natural gas burner, the container comprising:
a. an open-ended side wall secured along its bottom edge to a floor portion to define a space for containing the fluid or other substance to be heated;
b. an underside of the floor portion for resting on the gas burner;
c. a plurality of metal dowel members secured to and extending outward from the underside of the floor portion of the container for contacting the gas burner to define a means for capturing a greater quantity of heat from the gas burner and directing the heat into the container for heating the substance within the container to the desired temperature in a shorter time than a conventional container while reducing the amount of heat lost to the atmosphere.

13. The improved pot in claim 12, wherein the container may be constructed of aluminum, cast iron, copper, or any other suitable compound capable of heating substances therein, and the raised heat-conducting dowel members extend outward from the underside of the floor portion equidistant to define a flat surface resting on the burner.

14. An energy efficient container for heating liquids and like substances therein which comprises a plurality of dowel members extending out from an underside of a bottom of a container to more efficiently capture heat from a natural gas burner and direct the heat into the underside of the container for heating the liquids or like substances within the container to a desired temperature in a reduced amount of time than a conventional container, thereby reducing the amount of natural gas used.

15. The container in claim 14, further comprising small mounds on the interior bottom of the pot for further increasing the surface of the pot interior, which helps channel the heat in a circular motion, and helps induction of heat into the substance within the pot.

16. A method of constructing an energy efficient container capable of heating liquids and like substances therein, comprising the step of forming a raised heat-conducting surface on an underside of the bottom of the container to more efficiently capture heat from a natural gas burner and direct the heat into the underside of the container for heating the liquids or like substances within the container to a desired temperature in a reduced amount of time than a conventional container, thereby reducing the amount of natural gas used.

17. The method in claim 16, wherein the heat conducting surface on the underside of the pot bottom comprises a plurality of arms radiating outward along the underside of the pot or a plurality of metal dowels extending outward from the pot bottom to define the heat-conducting surface.

18. The method in claim 16, wherein the underside of the pot having the heat-conducting surface can be fabricated apart from the circular wall of the pot and secured to it during fabrication of the entire pot.

19. The method in claim 16, wherein the method produces a pot which is approximately 40% greater in heating efficiency than in a conventional heating container.
